(19) United States
(12) Patent Application Publication
(10) Pub. No.: US 2024/0199013 A1
(43) Pub. Date: Jun. 20, 2024

(54) SYSTEM AND METHOD FOR FULL SPEED RANGE ADAPTIVE CRUISE TRAILERING VELOCITY COMPENSATION ALGORITHM

(71) Applicant: GM GLOBAL TECHNOLOGY OPERATIONS LLC, Detroit, MI (US)

(72) Inventors: Benjamin T Llewellyn, Ypsilanti, MI (US); Chase Goodin, Howell, MI (US); Margo Bernadette Corsetti, Novi, MI (US); Tim Daavettila, Brighton, MI (US); Jaehoon Kim, Ann Arbor, MI (US); Travis Taylor, Ann Arbor, MI (US); Bryan M Joyner, Clarkston, MI (US)

(73) Assignee: GM GLOBAL TECHNOLOGY OPERATIONS LLC, Detroit, MI (US)

(21) Appl. No.: 18/065,808

(22) Filed: Dec. 14, 2022

(51) Int. Cl. B60W 30/14; B60W 10/10; B60W 10/18; B60W 40/076; B60W 40/13

(52) U.S. Cl. CPC B60W 30/143; B60W 10/10; B60W 10/18; B60W 40/076; B60W 40/13; B60W 2300/14; B60W 2510/0657; B60W 2530/10; B60W 2530/203; B60W 2552/15

(57) ABSTRACT

A trailering velocity compensation system in a cruise control system is disclosed. The system includes a controller that is configured to: determine whether activation conditions for a trailering velocity compensation algorithm are met, and when the activation conditions are met, adjust a speed error used by the cruise control system; adjust a speed offset for application of brakes used by the cruise control system; adjust a speed offset for release of brakes used by the cruise control system; determine a set speed offset for inhibiting engine torque; determine a set speed offset for releasing engine torque inhibiting; adjust a headway time gap value used by the cruise control system; and control vehicle speed based on the adjusted speed error, adjusted speed offset for application of brakes, adjusted speed offset for release of brakes, set speed offset for inhibiting engine torque, set speed offset for releasing engine torque inhibiting, and adjusted headway time gap value.

### INTRODUCTION

The technical field generally relates to systems, methods, and apparatuses for providing driver assistance and more particularly relates to systems, methods, and apparatuses for modifying cruise control behavior to reduce the likelihood of friction brake overuse.

Cruise control (also known as speed control, cruise command, autocruise, adaptive cruise, or by other names) is a system that automatically controls the speed of a motor vehicle. The system can take control over the throttle and friction brake controls of the vehicle to maintain a steady speed as set by the driver, or maintain a time gap headway to the vehicle ahead. When a vehicle is towing a trailer along a long negative grade, a cruise control feature in the vehicle may continuously apply the friction brakes along the negative grade to slow down the vehicle plus trailer. The continuous application of the friction brakes may result in friction brake overuse and cause the friction brakes to experience brake fade, which is a temporary and sudden reduction in braking power, caused by excessive heat in the system from braking repeatedly, under high loads or at high speeds. The continuous application of the friction brakes may also cause the cruise control feature to disengage or not be usable.

It is therefore desirable for methods, systems, and apparatuses for modifying cruise control behavior to reduce the likelihood of friction brake overuse while a vehicle tows a trailer. Furthermore, other desirable features and characteristics of the present disclosure will become apparent from the subsequent detailed description and the appended claims, taken in conjunction with the accompanying drawings and the foregoing technical field and background.

The information disclosed in this introduction is only for enhancement of understanding of the background of the present disclosure and therefore it may contain information that does not form the prior art that is already known in this country to a person of ordinary skill in the art.

### SUMMARY

Disclosed herein are a vehicle, methods, and systems for a trailering velocity compensation system for use with a cruise control feature for modifying the behavior of the cruise control feature while a vehicle is towing a trailer on continuous and varied grades. In one embodiment, a trailering velocity compensation system in a vehicle having a cruise control system is provided. The system includes a controller that is configured to: determine whether activation conditions for a trailering velocity compensation algorithm are met, wherein the activation conditions are met when vehicle speed is above a velocity threshold (VT), the road grade is less than a road grade threshold (GT), the system mass of the vehicle and a connected trailer is greater than a mass threshold (MT), and the cruise control system in the vehicle is engaged and not overridden. The controller is further configured, when the activation conditions are met, to engage trailering velocity compensation, wherein to engage trailering velocity compensation the controller is configured to: adjust a speed error used by the cruise control system; adjust a speed offset for application of brakes used by the cruise control system; adjust a speed offset for release of brakes used by the cruise control system; determine a set speed offset for inhibiting engine torque; determine a set speed offset for releasing engine torque inhibiting; adjust a headway time gap value to the vehicle ahead used by the cruise control system; and control vehicle speed based on the adjusted speed error, adjusted speed offset for application of brakes, adjusted speed offset for release of brakes, set speed offset for inhibiting engine torque, set speed offset for releasing engine torque inhibiting, and adjusted headway time gap value.

In various embodiments, the adjusted speed error, speed offset for application of brakes, speed offset for release of brakes, set speed offset for inhibiting engine torque, and set speed offset for releasing engine torque inhibiting are adjusted based on the system mass, road grade, and vehicle speed.

In various embodiments, the adjusted speed error is greater than the speed error used by the cruise control system.

In various embodiments, the adjusted speed error is further adjusted based on a cruise control set speed and a cruise control headway time gap.

In various embodiments, the controller is configured to: cause (e.g., via an electronic brake control module) vehicle friction brakes to be applied when the vehicle speed exceeds the adjusted speed offset for application of brakes plus the adjusted speed error; cause vehicle friction brakes to be released when the vehicle speed falls below the adjusted speed offset for release of brakes minus the adjusted speed error; cause a transmission gear change to inhibit speed when the vehicle speed is below a set speed offset for inhibiting engine torque minus the adjusted speed error and above the adjusted speed offset for release of brakes minus the adjusted speed error; and cause a transmission gear change to release speed inhibition when the vehicle speed is above a set speed offset for releasing engine torque plus the adjusted speed error.

In various embodiments, the controller is configured to modify the adjusted speed error, adjusted speed offset for application of brakes, adjusted speed offset for release of brakes, set speed offset for inhibiting engine torque, set speed offset for releasing engine torque inhibiting, and adjusted headway time gap value when a set speed used by the cruise control system is adjusted.

In various embodiments, the controller is further configured to disengage trailering velocity compensation when exit conditions are met.

In various embodiments, the exit conditions include one or more of vehicle speed below the velocity threshold (VT), road grade greater than the road grade threshold (GT), or the cruise control system in the vehicle is disengaged.

In another embodiment, a vehicle is disclosed. The vehicle includes an inertial measurement unit (IMU) configured to provide longitudinal acceleration and road grade; an integrated trailer brake controller (ITBC) configured to detect the presence of a trailer attached to the vehicle and to provide an estimate of the gross vehicle weight of the vehicle and trailer combination; an electronic brake control module (EBCM) for causing vehicle friction brakes to be applied; a transmission control module (TCM) for causing the switching of vehicle transmission gears, a propulsion control module (PCM) for causing engine torque inhibiting, and a trailering velocity compensation controller. The trailering velocity compensation controller is configured to: determine whether activation conditions for a trailering velocity compensation algorithm are met, wherein the activation conditions are met when vehicle speed is above a velocity threshold (VT), the road grade is less than a road grade threshold (GT), the system mass of the vehicle and a connected trailer is greater than a mass threshold (MT), and the cruise control system in the vehicle is engaged and not overridden. The trailering velocity compensation controller is further configured, when the activation conditions are met, to engage trailering velocity compensation, wherein to engage trailering velocity compensation the controller is configured to: adjust a speed error used by the cruise control system; adjust a speed offset for application of brakes used by the cruise control system; adjust a speed offset for release of brakes used by the cruise control system; determine a set speed offset for inhibiting engine torque; determine a set speed offset for releasing engine torque inhibiting; adjust a headway time gap value used by the cruise control system; and control vehicle speed based on the adjusted speed error, adjusted speed offset for application of brakes, adjusted speed offset for release of brakes, set speed offset for inhibiting engine torque, set speed offset for releasing engine torque inhibiting, and adjusted headway time gap value.

In various embodiments, the adjusted speed error, speed offset for application of brakes, speed offset for release of brakes, set speed offset for inhibiting engine torque, and set speed offset for releasing engine torque inhibiting are adjusted based on the system mass, road grade, and vehicle speed.

In various embodiments, the adjusted speed error is further adjusted based on a cruise control set speed and a cruise control headway time gap.

In various embodiments, the trailering velocity compensation controller is configured to: cause (e.g., via an electronic brake control module) vehicle friction brakes to be applied when the vehicle speed exceeds the adjusted speed offset for application of brakes plus the adjusted speed error; cause vehicle friction brakes to be released when the vehicle speed falls below the adjusted speed offset for release of brakes minus the adjusted speed error; cause a transmission gear change to inhibit speed when the vehicle speed is below a set speed offset for inhibiting engine torque minus the adjusted speed error and above the adjusted speed offset for release of brakes minus the adjusted speed error; and cause a transmission gear change to release speed inhibition when the vehicle speed is above a set speed offset for releasing engine torque plus the adjusted speed error.

In various embodiments, the controller is configured to modify the adjusted speed error, adjusted speed offset for application of brakes, adjusted speed offset for release of brakes, set speed offset for inhibiting engine torque, set speed offset for releasing engine torque inhibiting, and adjusted headway time gap value when a set speed used by the cruise control system is adjusted.

In various embodiments, the trailering velocity compensation controller is further configured to disengage trailering velocity compensation when exit conditions are met.

In various embodiments, the exit conditions include one or more of vehicle speed below the velocity threshold (VT), road grade greater than the road grade threshold (GT), or the cruise control system in the vehicle is disengaged.

In another embodiment, a method in a vehicle is disclosed. The method includes: determining whether activation conditions for a trailering velocity compensation algorithm are met, wherein the activation conditions are met when vehicle speed is above a velocity threshold (VT), road grade is less than a road grade threshold (GT), system mass of the vehicle and a connected trailer is greater than a mass threshold (MT), and the cruise control system in the vehicle is engaged and not overridden. The method further includes, when the activation conditions are met: engaging trailering velocity compensation, wherein engaging trailering velocity compensation includes: adjusting a speed error used by the cruise control system; adjusting a speed offset for application of brakes used by the cruise control system; adjusting a speed offset for release of brakes used by the cruise control system; determining a set speed offset for inhibiting engine torque; determining a set speed offset for releasing engine torque inhibiting; adjusting a headway time gap value used by the cruise control system; and controlling vehicle speed based on the adjusted speed error, adjusted speed offset for application of brakes, adjusted speed offset for release of brakes, set speed offset for inhibiting engine torque, set speed offset for releasing engine torque inhibiting, and adjusted headway time gap value.

In various embodiments, the method includes adjusting the speed error, speed offset for application of brakes, speed offset for release of brakes, set speed offset for inhibiting engine torque, and set speed offset for releasing engine torque inhibiting based on the system mass, road grade, and vehicle speed.

In various embodiments, the method further includes adjusting the speed error based on a cruise control set speed and a cruise control headway time gap.

In various embodiments, the method further includes causing vehicle brakes to be applied when the vehicle speed exceeds the adjusted speed offset for application of brakes plus the adjusted speed error; causing vehicle brakes to be released when the vehicle speed falls below the adjusted speed offset for release of brakes minus the adjusted speed error; causing a transmission gear change to inhibit speed when the vehicle speed is below a set speed offset for inhibiting engine torque minus the adjusted speed error and above the adjusted speed offset for release of brakes minus the adjusted speed error; and causing a transmission gear change to release speed inhibition when the vehicle speed is above a set speed offset for releasing engine torque plus the adjusted speed error.

In various embodiments, the method further includes adjusting the adjusted speed error, adjusted speed offset for application of brakes, adjusted speed offset for release of brakes, set speed offset for inhibiting engine torque, set speed offset for releasing engine torque inhibiting, and adjusted headway time gap value when a set speed used by the cruise control system is adjusted.

### BRIEF DESCRIPTION OF THE DRAWINGS

The exemplary embodiments will hereinafter be described in conjunction with the following drawing figures, wherein like numerals denote like elements, and wherein:

FIG. 1 is a block diagram depicting an example vehicle that includes a trailering velocity compensation system for modifying the behavior of a cruise control feature while a vehicle is towing a trailer, in accordance with an embodiment;

FIG. 2 is a block diagram depicting example vehicle systems used while implementing a trailering velocity compensation system for modifying the behavior of a cruise control feature while a vehicle is towing a trailer, in accordance with an embodiment;

FIG. 3 is a block diagram depicting an example trailering velocity compensation system, in accordance with an embodiment; and

FIG. 4 is a process flow chart depicting an example process in an example trailering velocity compensation system for modifying braking controls based on road grade while a cruise control feature is active, in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Cruise control (also known as speed control, cruise command, autocruise, adaptive cruise, or by other names) is a system that automatically controls the speed of a motor vehicle. The system can take control over the throttle and friction brake controls of the vehicle to maintain a steady speed as set by the driver. Full Speed Range Adaptive (FSRA) cruise is a cruise control feature designed to maintain headway time gap (e.g., set following distance behind another vehicle) and or a set speed accuracy of +/−1 mph. When a vehicle is towing a trailer using the FSRA cruise feature down long grades, the vehicle maintains speed with continuous low brake pressure application of friction brakes, and the vehicle will exit powertrain grade braking (e.g., downshifts by the transmission system to a lower gear to reduce engine torque) to a higher undesired transmission gear, leading to vehicle brake fade, brake over temperature, and eventually disengagement of the FSRA cruise feature.

The apparatus, systems, techniques, and articles provided herein disclose a trailering velocity compensation system for use with a cruise control feature such as a FSRA cruise feature. In various embodiments, the trailering velocity compensation system can modify the behavior of a cruise control feature while a vehicle is towing a trailer on continuous and varied grades by uniquely managing the use of braking based on a modified speed error. In various embodiments, the trailering velocity compensation algorithm can use grade inputs to optimize system braking performance by modifying the entry and exit points for braking based on the modified speed error for both open lane and headway time gap control. In various embodiments, the trailering velocity compensation system can prevent friction brake from being applied continuously during long stretches while towing a trailer to reduce the likelihood of brake fade and to reduce brake thermal temperatures. In various embodiments, the trailering velocity compensation system can control the vehicle speed error in a unique manner to minimize chassis friction brake load, maintain the transmission grade downshift in a lower gear, and optimize driver towing experience in FSRA.

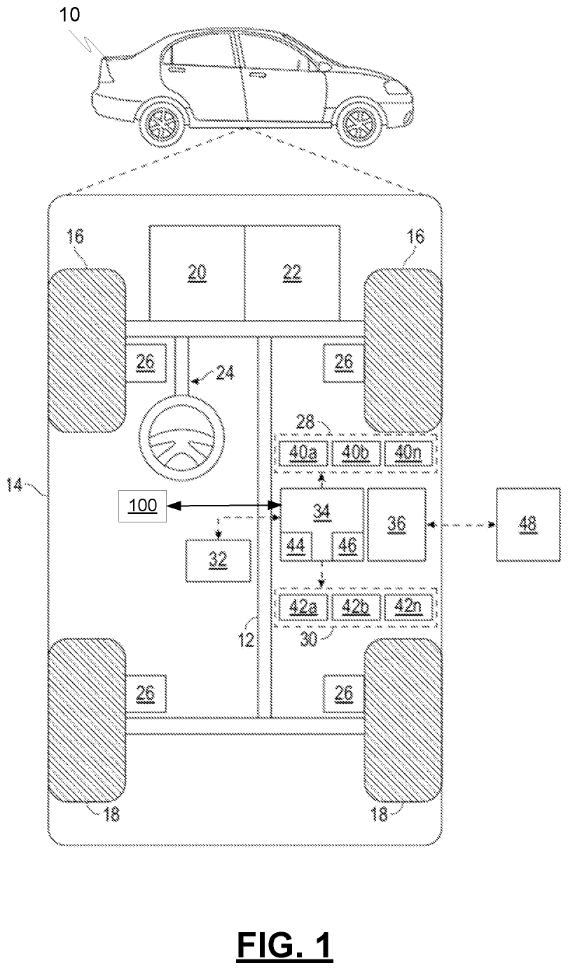

FIG. 1 is a block diagram depicting an example vehicle 10 that includes a trailering velocity compensation system 100 for modifying the behavior of a cruise control feature while a vehicle is towing a trailer. As depicted in FIG. 1, the example vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. The vehicle 10 is depicted in the illustrated embodiment as a passenger car, but other vehicle types, including trucks, sport utility vehicles (SUVs), recreational vehicles (RVs), etc., may also be used. The vehicle 10 may be capable of being driven manually, autonomously and/or semi-autonomously.

The vehicle 10 further includes a propulsion system 20, a transmission system 22 to transmit power from the propulsion system 20 to vehicle wheels 16-18, a steering system 24 to influence the position of the vehicle wheels 16-18, a brake system 26 to provide braking torque to the vehicle wheels 16-18, a sensor system 28, an actuator system 30, at least one data storage device 32, at least one controller 34, and a communication system 36 that is configured to wirelessly communicate information to and from other entities 48.

The sensor system 28 includes one or more sensing devices 40a-40n that sense observable conditions of the exterior environment and/or the interior environment of the autonomous vehicle 10. The sensing devices 40a-40n can include but are not limited to, radars, lidars, global positioning systems, optical cameras, thermal cameras, ultrasonic sensors, inertial measurement units, Ultra-Wideband sensors, and/or other sensors. The actuator system 30 includes one or more actuator devices 42a-42n that control one or more vehicle features such as, but not limited to, the propulsion system 20, the transmission system 22, the steering system 24, and the brake system 26.

The data storage device 32 stores data for use in automatically controlling the vehicle 10. The data storage device 32 may be part of the controller 34, separate from the controller 34, or part of the controller 34 and part of a separate system. The controller 34 includes at least one processor 44 and a computer-readable storage device or media 46. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The processor 44 can be any custom made or commercially available processor, a central processing unit (CPU), a graphics processing unit (GPU), an auxiliary processor among several processors associated with the controller 34, a semiconductor-based microprocessor (in the form of a microchip or chipset), a macro processor, any combination thereof, or generally any device for executing instructions. The computer-readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of several known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34.

The programming instructions may include one or more separate programs, each of which comprises an ordered listing of executable instructions for implementing logical functions. The one or more instructions of the controller 34, when executed by the processor 44, may configure the vehicle 10 to continuously calculate controllable steering angles for directing the articulated transport system to direct the final trailer in a desired direction and control the articulated transport system to direct the final trailer in the desired direction using the calculated controllable steering angles.

The trailering velocity compensation system 100 may include any number of sub-modules embedded within the controller 34, which may be combined and/or further partitioned to similarly implement systems and methods described herein. Additionally, inputs to the trailering velocity compensation system 100 may be received from the sensor system 28, received from other control modules (not shown) associated with the vehicle 10, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like.

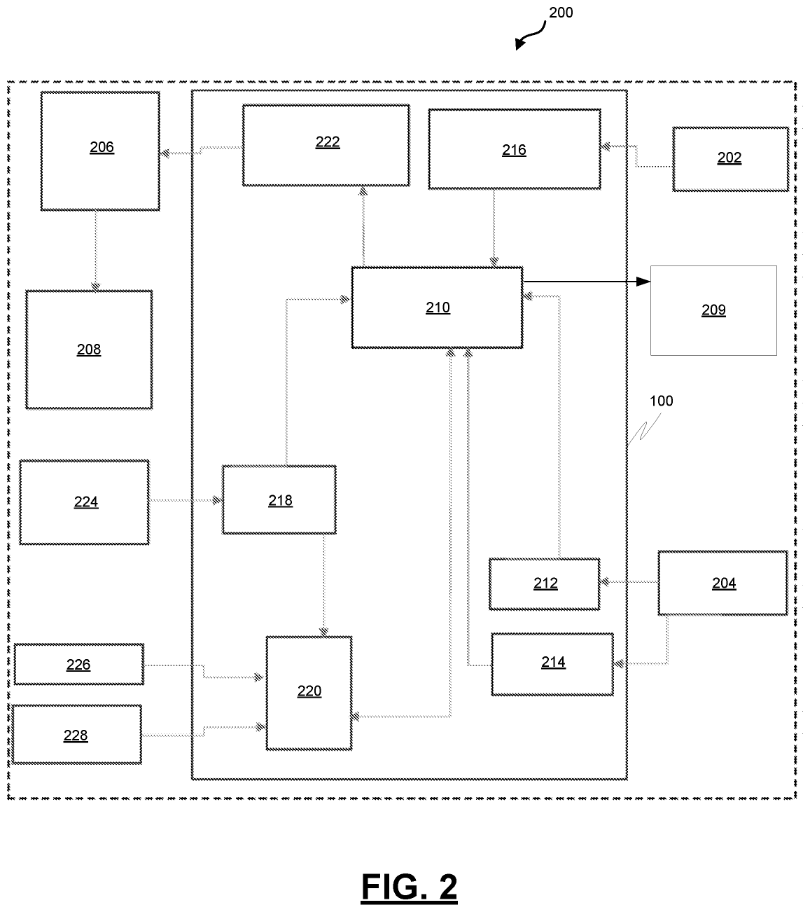

FIG. 2 is a block diagram depicting example vehicle systems 200 used while implementing a trailering velocity compensation system for modifying the behavior of a cruise control feature while a vehicle is towing a trailer. The example vehicle systems 200 include an example trailering velocity compensation system 100, an ITBC (integrated trailer brake control) module 202, an IMU (inertial measurement unit) 204, an EBCM (electronic brake control module) 206, a TGBCM (transmission grade braking control module) 208, a PCM (propulsion control module) 209, and various subsystems from a vehicle cruise control system.

The example trailering velocity compensation system 100 is implemented by a controller and is configured to receive input from the ITBC module 202, IMU 204, and the vehicle cruise control system. The example trailering velocity compensation system 100 includes a trailer velocity compensation algorithm 210, a grade determination module 212, a vehicle acceleration module 214, a trailer GCVWR (gross combined vehicle weight rating) detection/estimation module 216, a headway module 218, a set speed error control module 220, an auto braking request module 222.

The grade determination module 212 is configured to provide grade data for the road on which the vehicle and trailer are traveling for use in computations performed using the trailer velocity compensation algorithm 210. The grade data may be derived from longitudinal acceleration data provided by the IMU 204.

The vehicle acceleration module 214 is configured to provide vehicle acceleration data for the vehicle for use in computations performed using the trailer velocity compensation algorithm 210. The acceleration data may be derived from longitudinal acceleration data provided by the IMU 204.

The trailer GCVWR detection/estimation module 216 is configured to provide a combined vehicle and trailer weight estimate for use in computations performed using the trailer velocity compensation algorithm 210. The combined vehicle and trailer weight estimate may be derived from a GCVWR for the vehicle and trailer and detection of the trailer by the ITBC module 202.

The headway module 218 is configured to provide headway instructions to not exceed a set headway time gap to the vehicle ahead for use in computations performed using the trailer velocity compensation algorithm 210. The headway instructions may be derived from a selected “headway” time gap 224 entered into the vehicle cruise control system.

The set speed error control module 220 is configured to generate a set speed error for use in computations performed using the trailer velocity compensation algorithm 210. The generated set speed error may be derived from headway time gap data from the headway module 218, vehicle speed data 226 from vehicle wheel speed sensors (e.g., speedometer), a selected “set” speed 228 entered into the vehicle cruise control system. In various embodiments, the generated set speed error is different from the set speed error used by the vehicle cruise control system when the trailering velocity compensation system 100 is not engaged. In various embodiments, the set speed error used by the vehicle cruise control system is equal to the set speed minus the vehicle speed, or a headway speed error derived from gap speed to distance to vehicle ahead by the selected set speed.

The auto braking request module 222 is configured to generate braking instructions for the EBCM 206 and the TGBCM 208 for causing the vehicle friction braking systems to engage or disengage and for causing transmission grade braking gear shifts to engage or disengage. The braking instructions are derived from output from the trailer velocity compensation algorithm 210, which indicates when friction and transmission braking should commence and end.

The example trailering velocity compensation algorithm 210 determines when to exit auto braking (friction braking and transmission grade braking gear shifts) while the cruise control feature is engaged based on the GCVWR estimate, grade, acceleration, velocity, speed error. The example trailering velocity compensation algorithm 210 can command zero pedal torque right after the exit criteria is met to prevent the cruise control from adding additional undesired acceleration into the system based on small speed errors while towing a trailer. The PCM 209 is configured to receive commands for positive or zero pedal torque from the vehicle cruise control system to maintain speed. The example trailering velocity compensation algorithm 210 can pause or inhibit that torque request during activation.

The example trailering velocity compensation algorithm 210 creates a new vehicle speed error dead band for use with the cruise control feature. The example trailering velocity compensation algorithm 210 controls the speed error dead band based on GCVWR estimates, road grade, vehicle speed, and speed error. The example trailering velocity compensation algorithm 210 dynamically modifies the entry and exit of vehicle friction braking to maintain the lower vehicle transmission gear in transmission grade braking. The example trailering velocity compensation algorithm 210 resets the dynamic vehicle speed error dead band due to other criteria (i.e. incrementing the set speed) in order to optimize vehicle chassis friction brake torque and engine torque during grade transitions.

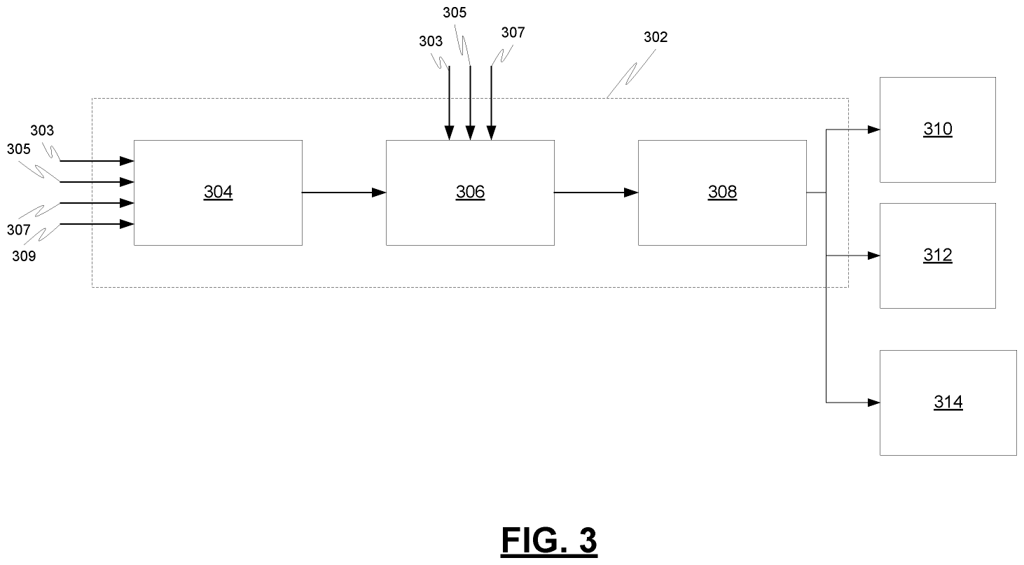

FIG. 3 is a block diagram depicting an example trailering velocity compensation system 302. The example trailering velocity compensation system 302 includes a monitoring module 304, a calculation module 306, and a control module 308.

The example monitoring module 304 is configured to determine based on received vehicle speed data 303, road grade data 305, system mass data 307, and cruise control engagement data 309 whether activation conditions for a trailering velocity compensation algorithm are met. The activation conditions are met when vehicle speed is above a velocity threshold (VT), road grade is less than a road grade threshold (Cr), system mass of the vehicle and a connected trailer is greater than a mass threshold (MT), and the cruise control system in the vehicle is engaged and not overridden. The example monitoring module 304 may include a grade determination module 212, a vehicle acceleration module 214, a trailer GCVWR detection/estimation module 216, a headway module 218, a set speed error control module 220, and logic for determining whether the activation conditions are met.

The example calculation module 306 is configured to execute the trailer velocity compensation algorithm 210 to determine when to apply friction braking and/or transmission grade brake transmission shifts. Through execution of the trailer velocity compensation algorithm 210, the example calculation module 306 is configured to adjust a speed error (e.g., via set speed error control module 220); adjust a speed offset for application of brakes used by the cruise control system; adjust a speed offset for release of brakes used by the cruise control system; determine a set speed offset for inhibiting engine torque to maintain transmission grade braking; determine a set speed offset for releasing engine torque inhibiting; and adjust a headway time gap value for determining when to apply friction and/or transmission braking. In various embodiments, the engine torque inhibit from the trailer velocity compensation algorithm 210 to the PCM 209 allows the transmission to maintain a lower gear state to aid negative grade towing.

The example control module 308 is configured to control vehicle speed (e.g., via the auto braking request module 222) based on the adjusted speed error, adjusted speed offset for application of brakes, adjusted speed offset for release of brakes, set speed offset for inhibiting engine torque (e.g., PCM 209), set speed offset for releasing engine torque inhibiting (e.g., PCM 209), adjusted headway time gap value, and vehicle acceleration. The example control module 308 is configured to generate braking instructions for the vehicle braking controls 310 (e.g., EBCM 206) and the vehicle transmission controls 312 (e.g., TGBCM 208) for causing the vehicle friction braking systems to engage or disengage and for causing transmission grade braking transmission gear shifts to engage or disengage. The example vehicle propulsion torque controls 314 (e.g., PCM 209) is configured to receive commands for positive or zero pedal torque from the vehicle cruise control system to maintain speed. The example control module 308 is configured to pause or inhibit those torque requests to the vehicle propulsion torque controls 314 during activation of the example trailering velocity compensation system 302.

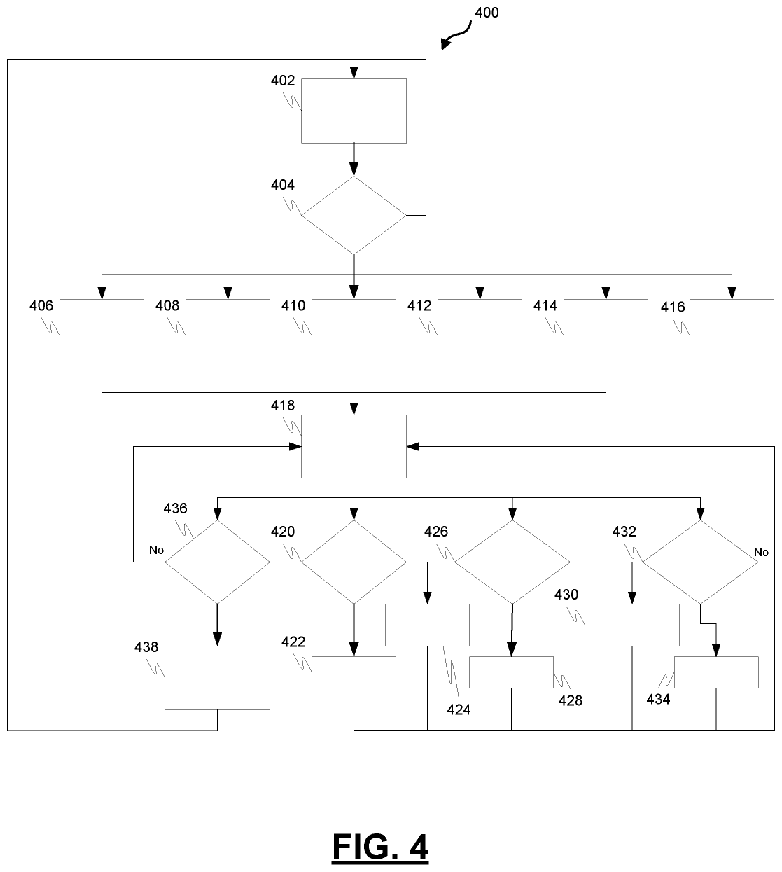

FIG. 4 is a process flow chart depicting an example process 400 in an example trailering velocity compensation system (e.g., example trailering velocity compensation system 302) for modifying braking controls based on road grade while a cruise control feature is active. The order of operation within process 400 is not limited to the sequential execution as illustrated in the FIG. 4 but may be performed in one or more varying orders as applicable and in accordance with the present disclosure.

At operation 402, the process 400 includes monitoring for activation conditions for a trailering velocity compensation algorithm. At decision 404, the process 400 includes determining if the activation conditions are met. In various embodiments, the activation conditions are met when vehicle speed is above a velocity threshold (VT), road grade is less than a road grade threshold (Gr), system mass of the vehicle and a connected trailer is greater than a mass threshold (MT), and the cruise control system in the vehicle is engaged and not overridden. If the activation conditions are not met (no at decision 404), the process 400 includes continuing to monitor for activation conditions. If the activation conditions are met (yes at decision 404), the process 400 includes proceeding to operations 406, 408, 410, 412, 414, 416, and 418.

At operation 406, the process 400 includes adjusting a speed error used by the cruise control system. At operation 408, the process 400 includes adjusting a speed offset for application of brakes used by the cruise control system. At operation 410, the process 400 includes adjusting a speed offset for release of brakes used by the cruise control system. At operation 412, the process 400 includes determining a set speed offset for inhibiting engine torque. At operation 414, the process 400 includes determining a set speed offset for releasing engine torque inhibiting. At operation 416, the process 400 includes adjusting a headway time gap value used by the cruise control system. At operation 418, the trailering velocity compensation algorithm is engaged.

In various embodiments, the adjusted speed error, adjusted speed offset for application of brakes, adjusted speed offset for release of brakes, set speed offset for inhibiting engine torque, and set speed offset for releasing engine torque inhibiting are adjusted based on the system mass, road grade, and vehicle speed. In various embodiments, the adjusted speed error is further adjusted based on a cruise control set speed and a cruise control headway time gap. In various embodiments, the adjusted speed error is greater than the speed error used by the cruise control system.

At decision 420, the process 400 includes determining whether friction braking conditions are met. In various embodiments, friction brakes are to be applied when the vehicle speed exceeds the adjusted speed offset for application of brakes plus the adjusted speed error conditions. In various embodiments, friction brakes are to be released when the vehicle speed falls below the adjusted speed offset for release of brakes minus the adjusted speed error. When the conditions for applying friction brakes are met, the process includes, at operation 422, applying the friction brakes. When the conditions for releasing friction brakes are met, the process includes, at operation 424, releasing the friction brakes if they are being applied. The trailering velocity algorithm remains engaged (at operation 418) after performing operations 422 and 424.

At decision 426, the process 400 includes determining whether engine torque inhibition (e.g., via transmission braking) conditions are met. In various embodiments, engine torque is to be inhibited (e.g., via a transmission gear change to inhibit engine torque) when the vehicle speed is below a set speed offset for inhibiting engine torque minus the adjusted speed error and above the adjusted speed offset for release of friction brakes minus the adjusted speed error. In various embodiments, the engine torque inhibiting is to be released (e.g., via a transmission gear change) when the vehicle speed is above a set speed offset for releasing engine torque plus the adjusted speed error. When the conditions for inhibiting engine torque are met, the process includes, at operation 428, inhibiting engine torque, e.g., via a transmission gear change. When the conditions for releasing engine torque inhibiting are met, the process includes, at operation 430, releasing engine torque inhibiting if is are being applied. The trailering velocity algorithm remains engaged (at operation 418) after performing operations 428 and 430.

At decision 432, the process 400 includes determining whether any offsets, e.g., set speed offset for application of brakes, set speed offset for release of brakes, set speed offset for inhibiting engine torque, set speed offset for releasing engine torque inhibiting, speed error, or headway time gap, should be adjusted. In various embodiments, offsets may need to be adjusted when a set speed set in the vehicle cruise control system is adjusted. When an offset needs to be adjusted (yes at decision 432), the process 400 includes, at operation 434, adjusting the offset. The trailering velocity algorithm remains engaged (at operation 418) after performing operation 434 and after determining a no at decision 432.

At decision 436, the process 400 includes determining if exit conditions exist for exiting from the trailering velocity compensation algorithm. In various embodiments, the exit conditions include one or more of vehicle speed below the velocity threshold (VT), road grade greater than the road grade threshold (GT), or the cruise control system in the vehicle is disengaged. If exit conditions exist (yes at decision 436), the process 400 includes disengaging the trailering velocity compensation algorithm at operation 438 and proceeding to monitoring for activation conditions at operation 402. If exit conditions do not exist (no at decision 436), the trailering velocity algorithm remains engaged (at operation 418).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A trailering velocity compensation system in a vehicle having a cruise control system, the system comprising a controller, the controller configured to:
determine whether activation conditions for a trailering velocity compensation algorithm are met, wherein the activation conditions are met when vehicle speed is above a velocity threshold (VT), road grade is less than a road grade threshold (Cr), system mass of the vehicle and a connected trailer is greater than a mass threshold (MT), and the cruise control system in the vehicle is engaged and not overridden; and
when the activation conditions are met, engage trailering velocity compensation, wherein to engage trailering velocity compensation the controller is configured to:
adjust a speed error used by the cruise control system;
adjust a speed offset for application of brakes used by the cruise control system;
adjust a speed offset for release of brakes used by the cruise control system;
determine a set speed offset for inhibiting engine torque;
determine a set speed offset for releasing engine torque inhibiting;
adjust a headway time gap value used by the cruise control system; and
control vehicle speed based on the adjusted speed error, adjusted speed offset for application of brakes, adjusted speed offset for release of brakes, set speed offset for inhibiting engine torque, set speed offset for releasing engine torque inhibiting, and adjusted headway time gap value.

2. The trailering velocity compensation system of claim 1, wherein the adjusted speed error, speed offset for application of brakes, speed offset for release of brakes, set speed offset for inhibiting engine torque, and set speed offset for releasing engine torque inhibiting are adjusted based on the system mass, road grade, and vehicle speed.

3. The trailering velocity compensation system of claim 2, wherein the adjusted speed error is greater than the speed error used by the cruise control system.

4. The trailering velocity compensation system of claim 2, wherein the adjusted speed error is further adjusted based on a cruise control set speed and a cruise control headway time gap.

5. The trailering velocity compensation system of claim 1, wherein the controller is configured to:
cause vehicle brakes to be applied when the vehicle speed exceeds the adjusted speed offset for application of brakes plus the adjusted speed error;
cause vehicle brakes to be released when the vehicle speed falls below the adjusted speed offset for release of brakes minus the adjusted speed error;
cause a transmission gear change to inhibit speed when the vehicle speed is below a set speed offset for inhibiting engine torque minus the adjusted speed error and above the adjusted speed offset for release of brakes minus the adjusted speed error; and
cause a transmission gear change to release speed inhibition when the vehicle speed is above a set speed offset for releasing engine torque plus the adjusted speed error.

6. The trailering velocity compensation system of claim 1, wherein the controller is configured to modify the adjusted speed error, adjusted speed offset for application of brakes, adjusted speed offset for release of brakes, set speed offset for inhibiting engine torque, set speed offset for releasing engine torque inhibiting, and adjusted headway time gap value when a set speed used by the cruise control system is adjusted.

7. The trailering velocity compensation system of claim 1, wherein the controller is further configured to disengage trailering velocity compensation when exit conditions are met.

8. The trailering velocity compensation system of claim 7, wherein the exit conditions comprise one or more of vehicle speed below the velocity threshold (VT), road grade greater than the road grade threshold (Cr), or the cruise control system in the vehicle is disengaged.

9. A vehicle comprising:
an inertial measurement unit (IMU) configured to provide longitudinal acceleration and road grade;
an integrated trailer brake controller (ITBC) configured to detect whether a trailer is attached to the vehicle and to provide an estimate of gross vehicle weight of the vehicle and trailer combination;
an electronic brake control module (EBCM) for causing vehicle brakes to be applied;
a transmission control module (TCM) for causing vehicle transmission gears to be switched;
a propulsion control module (PCM) for causing engine torque inhibiting; and
a trailering velocity compensation controller in a cruise control system configured to:
determine whether activation conditions for a trailering velocity compensation algorithm are met, wherein the activation conditions are met when vehicle speed is above a velocity threshold (VT), road grade is less than a road grade threshold (Cr), system mass of the vehicle and a connected trailer is greater than a mass threshold (MT), and the cruise control system in the vehicle is engaged and not overridden; and
when the activation conditions are met, engage trailering velocity compensation, wherein to engage trailering velocity compensation the controller is configured to:
adjust a speed error used by the cruise control system;
adjust a speed offset for application of brakes used by the cruise control system;
adjust a speed offset for release of brakes used by the cruise control system;
determine a set speed offset for inhibiting engine torque;
determine a set speed offset for releasing engine torque inhibiting;
adjust a headway time gap value used by the cruise control system; and
control vehicle speed based on the adjusted speed error, adjusted speed offset for application of brakes, adjusted speed offset for release of brakes, set speed offset for inhibiting engine torque, set speed offset for releasing engine torque inhibiting, and adjusted headway time gap value.

10. The vehicle of claim 9, wherein the adjusted speed error, speed offset for application of brakes, speed offset for release of brakes, set speed offset for inhibiting engine torque, and set speed offset for releasing engine torque inhibiting are adjusted based on the system mass, road grade, and vehicle speed.

11. The vehicle of claim 10, wherein the adjusted speed error is further adjusted based on a cruise control set speed and a cruise control headway time gap.

12. The vehicle of claim 9, wherein the trailering velocity compensation controller is configured to:
cause vehicle brakes to be applied when the vehicle speed exceeds the adjusted speed offset for application of brakes plus the adjusted speed error;
cause vehicle brakes to be released when the vehicle speed falls below the adjusted speed offset for release of brakes minus the adjusted speed error;
cause a transmission gear change to inhibit speed when the vehicle speed is below a set speed offset for inhibiting engine torque minus the adjusted speed error and above the adjusted speed offset for release of brakes minus the adjusted speed error; and
cause a transmission gear change to release speed inhibition when the vehicle speed is above a set speed offset for releasing engine torque plus the adjusted speed error.

13. The vehicle of claim 9, wherein the controller is configured to modify the adjusted speed error, adjusted speed offset for application of brakes, adjusted speed offset for release of brakes, set speed offset for inhibiting engine torque, set speed offset for releasing engine torque inhibiting, and adjusted headway time gap value when a set speed used by the cruise control system is adjusted.

14. The vehicle of claim 9, wherein the trailering velocity compensation controller is further configured to disengage trailering velocity compensation when exit conditions are met.

15. The vehicle of claim 14, wherein the exit conditions comprise one or more of vehicle speed below the velocity threshold (VT), road grade greater than the road grade threshold (Gr), or the cruise control system in the vehicle is disengaged.

16. A method in a vehicle, comprising:
determining whether activation conditions for a trailering velocity compensation algorithm are met, wherein the activation conditions are met when vehicle speed is above a velocity threshold (VT), road grade is less than a road grade threshold (Gr), system mass of the vehicle and a connected trailer is greater than a mass threshold (MT), and a cruise control system in the vehicle is engaged and not overridden; and
when the activation conditions are met, engaging trailering velocity compensation, wherein engaging trailering velocity compensation comprises:
adjusting a speed error used by the cruise control system;
adjusting a speed offset for application of brakes used by the cruise control system;
adjusting a speed offset for release of brakes used by the cruise control system;
determining a set speed offset for inhibiting engine torque;
determining a set speed offset for releasing engine torque inhibiting;
adjusting a headway time gap value used by the cruise control system; and
controlling vehicle speed based on the adjusted speed error, adjusted speed offset for application of brakes, adjusted speed offset for release of brakes, set speed offset for inhibiting engine torque, set speed offset for releasing engine torque inhibiting, and adjusted headway time gap value.

17. The method of claim 16, comprising adjusting the speed error, speed offset for application of brakes, speed offset for release of brakes, set speed offset for inhibiting engine torque, and set speed offset for releasing engine torque inhibiting based on the system mass, road grade, and vehicle speed.

18. The method of claim 17, further comprising adjusting the speed error based on a cruise control set speed and a cruise control headway time gap.

19. The method of claim 16, further comprising:
causing vehicle brakes to be applied when the vehicle speed exceeds the adjusted speed offset for application of brakes plus the adjusted speed error;
causing vehicle brakes to be released when the vehicle speed falls below the adjusted speed offset for release of brakes minus the adjusted speed error;
causing a transmission gear change to inhibit speed when the vehicle speed is below a set speed offset for inhibiting engine torque minus the adjusted speed error and above the adjusted speed offset for release of brakes minus the adjusted speed error; and
causing a transmission gear change to release speed inhibition when the vehicle speed is above a set speed offset for releasing engine torque plus the adjusted speed error.

20. The method of claim 16, further comprising adjusting the adjusted speed error, adjusted speed offset for application of brakes, adjusted speed offset for release of brakes, set speed offset for inhibiting engine torque, set speed offset for releasing engine torque inhibiting, and adjusted headway time gap value when a set speed used by the cruise control system is adjusted.
